(19) United States
(12) Patent Application Publication
(10) Pub. No.: US 2025/0137845 A1
(43) Pub. Date: May 1, 2025

(54) TROPICAL CYCLONE SYMMETRY STRUCTURE ANALYSIS METHOD AND APPARATUS, DEVICE, AND STORAGE MEDIUM

(71) Applicant: SHENZHEN INSTITUTES OF ADVANCED TECHNOLOGY CHINESE ACADEMY OF SCIENCES, Shenzhen (CN)

(72) Inventors: Qinglan LI, Shenzhen (CN); Jiali ZHANG, Shenzhen (CN); Gangya ZHU, Shenzhen (CN)

(73) Assignee: SHENZHEN INSTITUTES OF ADVANCED TECHNOLOGY CHINESE ACADEMY OF SCIENCES, Shenzhen (CN)

(21) Appl. No.: 19/003,532

(22) Filed: Dec. 27, 2024

Related U.S. Application Data
(63) Continuation of application No. PCT/CN2022/138216, filed on Dec. 9, 2022.

(30) Foreign Application Priority Data
Nov. 10, 2022 (CN) 202211402668.X

(51) Int. Cl. G01J 5/00; G01W 1/02; G06F 16/901

(52) U.S. Cl. CPC G01J 5/007; G01W 1/02; G06F 16/9024

(57) ABSTRACT

Disclosed are a tropical cyclone symmetry structure analysis method and apparatus, a device, and a storage medium. TC locations and TC intensities are acquired based on TC best track datasets; polar coordinate systems are created with the TC locations as origins; hourly infrared brightness temperature data are acquired based on satellite data, and are interpolated into the corresponding polar grids to obtain infrared brightness temperature polar grid data; then convection symmetry indexes of inner-core regions of TCs are calculated based on the infrared brightness temperature polar grid data; and finally, the relationship between the convective symmetry indexes and the TC intensities is analyzed.

### CROSS-REFERENCE TO RELATED APPLICATIONS

The application claims priority to Chinese patent application No. 202211402668.X, filed on Nov. 10, 2022, the entire contents of which are incorporated herein by reference.

### TECHNICAL FIELD

The present disclosure relates to the technical field of meteorological analysis, in particular to a tropical cyclone symmetry structure analysis method and apparatus, a device, and a storage medium.

### BACKGROUND

Tropical cyclones (TCs) are one of the most complex weather systems in the atmosphere, involving multiple scales of thermal and dynamic processes and interactions between different scales. In coastal areas, with economic development, the disaster losses caused by TCs are gradually increasing. Therefore, the accuracy of TC track and intensity forecasting is crucial for disaster mitigation. With the development of observation techniques, especially the application of unconventional observation data such as satellite radar, the accuracy of TC track forecasting is significantly improved. However, the progress in TC intensity and structure forecasting remains slow. TC intensity forecasting has always been a difficult challenge task, especially the rapid intensification (RI) of TCs, defined as 24-hr TC maximum sustained surface wind speed increase greater than 30 knots (kt, 1 kt=0.514 m/s), is difficult to predict, and improving RI forecast skill has been the highest priority of the National Hurricane Center.

The difficulty of forecasting RI stems from a general lack of understanding of the physical mechanisms that are responsible for these rare events. For decades, many scholars have been devoted to studying the evolution mechanisms of tropical cyclones. It is well known that TC intensity change is sensitive to environmental conditions. And internal storm dynamics is also recognized as an important factor in RI processes, given favorable environmental conditions. It is necessary to further explore the relationship between inner-core structure and evolution characteristics of TCs and rapid intensification. The results of research on tropical cyclone intensification mechanisms have shown that the release of latent heat from water vapor condensation in convective activities is considered as the main energy source for the development and maintenance of the secondary circulation of tropical cyclones. However, the organized severe convective activity often appears in an asymmetric form within the circulation of TCs, and the asymmetric convective activity is particularly evident during the early development stage and weakening stage of TCs. Therefore, studying the relationship between asymmetric convective characteristics and intensity changes is of great significance for perfecting asymmetric intensification mechanisms of tropical cyclones.

Currently, the research on asymmetric characteristics of TCs mainly includes the following aspects: (1) using GMS-5 satellite and radar data to study the asymmetric distribution of convection within TCs that make landfall along the coast of southern China; (2) many studies have used Fourier expansion of the brightness temperature (TBB) field along the azimuth angle to represent the degree of convective asymmetry by calculating the one-wave asymmetry value; (3) in the Statistical Hurricane Intensity Prediction Scheme (SHIPS) Rapid Intensification Index (RII) model, the percentage of infrared brightness temperatures below 30° C. (PX30) within 50 to 200 km radius, as well as the standard deviation of infrared brightness temperatures (SDBT) in the same region, are used as predictive factors to indicate the convective symmetry around the center of TCs. However, among the three approaches mentioned above, the first one only performs comparative analysis on the asymmetric distribution of convection in different quadrants of typical TC cases, making it difficult to form a consistent measurement indicator for all TCs; the second approach represents the uniformity of convective distribution through the maximum amplitude of the one-wave asymmetry value, tending to focus on the asymmetric convective characteristics of the outer spiral rainband region of TCs; and the third approach is susceptible to interference from extreme brightness temperature values, which can easily lead to large fluctuations.

### SUMMARY

In view of this, the present disclosure provides a tropical cyclone symmetry structure analysis method and apparatus, a device, and a storage medium, which define convection symmetry indexes of the inner-core regions of TCs, and analyze the relationship between the index and the evolution of TC intensity.

To solve the above technical problems, one technical solution adopted by the present disclosure is to provide a tropical cyclone symmetry structure analysis method, which includes: acquiring TC best track datasets in a preset time period, which include TC locations (latitude and longitude of the TCs center) and TC intensities (the maximum sustained wind speed near the TCs center) with six-hour temporal resolution; using linear interpolation to acquire hourly TC locations and TC intensities; creating corresponding polar coordinate systems with the TC locations as the origins; acquiring hourly infrared brightness temperature (TBB) from satellite data; interpolating the infrared brightness temperature data into the corresponding polar grids based on a temporal correspondence to obtain infrared brightness temperature polar grid data; calculating convection symmetry indexes of preset inner-core regions of TCs based on the infrared brightness temperature polar grid data; and analyzing the relationship between the convection symmetry indexes and TC intensities.

As a further improvement of the present disclosure, calculating convection symmetry indexes of TCs based on the infrared brightness temperature polar grid data includes: calculating a 10% quantile and a 90% quantile of the infrared brightness temperature polar grid data of the preset inner-core regions of TCs; and calculating convection symmetry indexes of TCs in combination with the difference of the 10% quantile and the 90% quantile.

As a further improvement of the present disclosure, the calculation formula for the convection symmetry index is expressed as: Symmetric Ratio=1−(90% TBB−10% TBB)/maximum (90% TBB−10% TBB), where Symmetric Ratio represents the convection symmetry index, TBB represents the infrared brightness temperature polar grid data, and maximum (90% TBB−10% TBB) represents a preset climate value.

As a further improvement of the present disclosure, interpolating the infrared brightness temperature data into polar grids based on a temporal correspondence to obtain infrared brightness temperature polar grid data includes: identifying target polar grid points with a spacing of 4 km in the direction of radius r and 5° in the direction of azimuthal angle θ of each polar coordinate system.

As a further improvement of the present disclosure, the preset inner-core region of the tropical cyclone includes a circular ring region taking the center of the tropical cyclone as a circle center and located between a first preset radius and a second preset radius, wherein the first preset radius is smaller than the second preset radius.

As a further improvement of the present disclosure, analyzing the relationship between the convection symmetry indexes and the TC intensities includes: performing comparative analysis on first characteristics of convection symmetry indexes during the rapid intensification phase and the non-rapid intensification phase of TCs, and constructing a first boxplot for analysis, wherein the rapid intensification phase and the non-rapid intensification phase are determined based on the magnitude of the continuously increasing maximum sustained wind speed within a preset time period; performing comparative analysis on second characteristics of the convection symmetry index during the rapid intensification phase of TCs of different grades, and constructing a second boxplot for analysis, wherein the grade of a tropical cyclone is determined based on the magnitude of the maximum sustained wind speed near the TC center; and performing comparative analysis on third characteristics of the convection symmetry index varying with time during the rapid intensification phase of the tropical cyclones, and constructing a third boxplot for analysis.

As a further improvement of the present disclosure, the convection symmetry index is added as a potential factor for TC intensity prediction models.

To solve the above technical problem, another technical solution adopted by the present disclosure is to provide a tropical cyclone symmetry structure analysis apparatus, including: a first acquisition module, configured to acquire TC best track datasets in a preset time period, which include TC locations (latitude and longitude of the TCs center) and TC intensities (the maximum sustained wind speed near the TCs center) with six-hour temporal resolution, using linear interpolation to get hourly TC locations and TC intensities; a creation module, configured to create corresponding polar coordinate systems with TC locations as origins; a second acquisition module, configured to acquire hourly infrared brightness temperature from satellite data, and interpolate the infrared brightness temperature data into the corresponding polar grids based on a temporal correspondence to obtain infrared brightness temperature polar grid data; a calculation module, configured to calculate convection symmetry indexes of preset inner-core regions of TCs based on the infrared brightness temperature polar grid data; and an analysis module, configured to analyze the relationship between the convection symmetry indexes and TC intensities.

To solve the above technical problem, yet another technical solution adopted by the present disclosure is to provide a computer device, including a processor, and a memory coupled to the processor, wherein the memory stores program instructions, and the program instructions, when executed by the processor, cause the processor to execute the steps of the tropical cyclone symmetry structure analysis method of any of the above.

In order to solve the above technical problems, yet another technical solution adopted by the present disclosure is to provide a storage medium, storing program instructions capable of implementing the tropical cyclone symmetry structure analysis method according to any one of the above.

The present disclosure has the beneficial effects that in the tropical cyclone symmetry structure analysis method, the hourly TC positions and TC intensities of the tropical cyclones are determined based on the TC best track datasets, polar coordinate systems are created with the TC locations as the origins, the hourly infrared brightness temperature data are acquired from satellite data, and are interpolated into polar grids based on the temporal correspondence to obtain infrared brightness temperature polar grid data, then the infrared brightness temperature polar grid data are used to define the convection symmetry indexes of the inner-core regions of TCs, and finally, the relationship between the convection symmetry indexes and the TC intensities is analyzed, so that researchers can conveniently explore the application of the convection symmetry indexes in TC intensity forecasting.

### BRIEF DESCRIPTION OF DRAWINGS

FIG. 1 is a flowchart of a tropical cyclone symmetry structure analysis method according to an embodiment of the present disclosure;

FIG. 2 is a statistical boxplot of convection symmetry indexes in the Northwestern Pacific Ocean during the rapid intensification (RI) phase and the non-rapid intensification (No-RI) phase from 2009 to 2021;

FIG. 3 is a statistical boxplot of convection symmetry indexes with different grades undergoing rapid intensification in the Northwestern Pacific Ocean from 2009 to 2021;

FIG. 4 is a statistical boxplot of convection symmetry indexes varying with time during the rapid intensification of TCs in the Northwestern Pacific Ocean from 2009 to 2021;

FIG. 5 is a schematic diagram of functional modules of a tropical cyclone symmetry structure analysis apparatus according to an embodiment of the present disclosure;

FIG. 6 is a structural schematic diagram of a computer device according to an embodiment of the present disclosure; and

FIG. 7 is a structural schematic diagram of a storage medium according to an embodiment of the present disclosure.

### DETAILED DESCRIPTION OF THE EMBODIMENTS

The technical solutions in the embodiments of the present disclosure will be clearly and completely described below in conjunction with the drawings in the embodiments of the present disclosure, and it is obvious that the described embodiments are only a part of the embodiments of the present disclosure, rather than all of the embodiments. Based on the embodiments in the present disclosure, all other embodiments obtained by those of ordinary skill in the art without making inventive labor, belong to the scope of protection of the present disclosure.

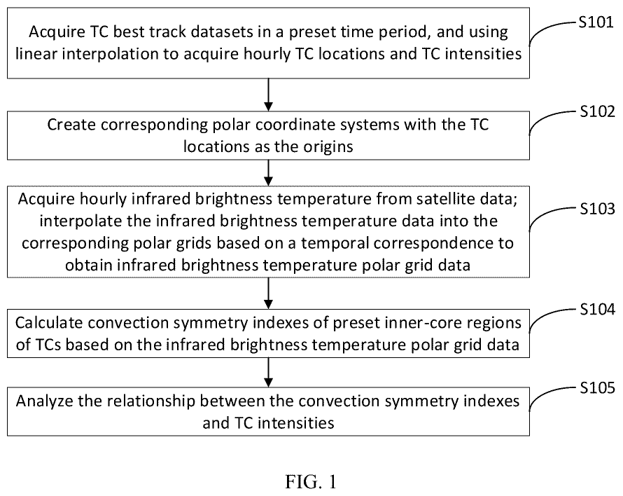

FIG. 1 is a flowchart of a tropical cyclone symmetry structure analysis method according to an embodiment of the present disclosure. It should be noted that the process of the present disclosure is not limited to the sequence of processes shown in FIG. 1 with substantially the same results. As shown in FIG. 1, the tropical cyclone symmetry structure analysis method includes the following steps:

Step S101: acquiring TC best track datasets in a preset time period, which include TC locations (latitude and longitude of the TCs center) and TC intensities (the maximum sustained wind speed near the TCs center) with six-hour temporal resolution.

It should be noted that the TC best track datasets (elements are TCs' time, location, maximum sustained wind speed, central pressure, etc.) in the Northwest Pacific Ocean (which may also be the Atlantic Ocean, the Indian Ocean, etc.) for multiple years can be downloaded from the official websites of institutions such as the Shanghai Typhoon Institute, the Joint Typhoon Warning Center of the United States, and the Japan Meteorological Agency. In this embodiment, it is assumed that the tropical cyclone moves at a constant speed and intensifies (or weakens) uniformly between two recording times. Through linear interpolation, the hourly locations and intensity values of TCs can be obtained.

Step S102: creating corresponding polar coordinate systems with the center locations of TCs as the origins.

Step S103: acquiring hourly infrared brightness temperature data during the research period, and interpolating the infrared brightness temperature data into corresponding polar grids by a radial basis function (RBF) interpolation method based on a temporal correspondence to obtain infrared brightness temperature polar grid data.

It should be noted that since the satellite observation range can cover most of the oceanic areas, the insufficiency of the atmospheric detection capabilities over the ocean is largely remedied, thus providing richer remote sensing data for tropical cyclone research. Additionally, the infrared brightness temperature data has a good correspondence with severe convection and convection-induced precipitation, thus being capable of effectively indicating the strength of convection. Lower brightness temperature values indicate higher cloud-top extension heights and more vigorous convection. Tropical cyclones that undergo rapid intensification, even under moderate shear environments, are accompanied by strong convective cyclonic rotation during the rapid intensification process, which leads to the TC structure tending to become more symmetric in the later stages of rapid intensification. Therefore, in this embodiment, the brightness temperature values of the long-wave infrared channel of the FY-2 series satellite are used to analyze the asymmetric structural characteristics of convection in the inner core of TC.

Specifically, in this embodiment, hourly FY-2 full-disk nominal image files and corresponding latitude and longitude reference tables are downloaded from the Fengyun Satellite Remote Sensing Data Service Network. Then, the downloaded data are processed to obtain the brightness temperature values of the long-wave infrared channel (wavelength range: 10.3-11.3 μm). Then the hourly brightness temperature values of the long-wave infrared channel are interpolated into corresponding polar grids of the tropical cyclones according to the temporal correspondence to obtain infrared brightness temperature polar grid data specifically includes:

1, identifying target polar grid points with a spacing of 4 km in the direction of radius r and 5° in the direction of azimuthal angle θ of each polar coordinate system.

2, interpolating the infrared brightness temperature data into the target polar grid points of the corresponding polar coordinate systems based on the temporal correspondence to obtain infrared brightness temperature polar grid data.

Step S104: calculating convection symmetry indexes of preset inner-core regions of TCs based on the infrared brightness temperature polar grid data.

It should be noted that the convective activities of the tropical cyclones studied in this embodiment are limited to the preset inner-core regions of the tropical cyclones. Generally, the inner-core region of TC is defined as the region within a radius of 1° (approximately within a radius of 100 km in tropical and subtropical regions), centered on the TC center. However, in satellite images with pronounced tropical cyclone eyes, downward flow prevails in the tropical cyclone eyes, and the brightness temperature value is relatively high. In order to eliminate the interference of tropical cyclone eyes, this embodiment sets the preset inner-core region of the tropical cyclone as a circular ring region taking the TC center as the circle center and located between a first preset radius and a second preset radius, the first preset radius being smaller than the second preset radius. Preferably, in this embodiment, the first preset radius is preferably 50 km, and the second preset radius is preferably 100 km.

Further, step S104 specifically includes:
1, calculating the 10% quantile and 90% quantile of infrared brightness temperature polar grid data of the preset inner-core regions.
2, calculating convection symmetry indexes in combination with the difference of the 10% quantile and the 90% quantile.

The calculation formula for the convection symmetry index is expressed as:

$$Symmetric Ratio = 1 - ( 90 \% TBB - 10 \% TBB ) / maximum ( 90 \% TBB - 10 \% TBB ) ,$$

where Symmetric Ratio represents the convection symmetry index, TBB represents the infrared brightness temperature polar grid data, and maximum (90% TBB−10% TBB) represents a preset climate value. This embodiment is based on tropical cyclones in the Northwest Pacific Ocean from 2009 to 2021, so the preset climate value is set to 105.

Step S105: analyzing the relationship between the convection symmetry indexes and the TC intensities.

Specifically, after the convection symmetry indexes of all TCs are obtained, analysis is performed in conjunction with intensity changes.

Further, step S105 specifically includes:

1, performing comparative analysis on first characteristics of the convection symmetry index during the rapid intensification phase and the non-rapid intensification phase of tropical cyclones, and constructing a first boxplot for analysis, wherein the rapid intensification phase and the non-rapid intensification phase are determined based on the magnitude of the continuously increasing maximum sustained wind speed within a preset time period.

It should be noted that the most commonly used criterion for rapid intensification of tropical cyclones is currently defined as a continuous increase in the maximum sustained wind speed reaching 15 m/s within 24 hours. However, some studies have pointed out that the 24-hour criterion tends to favor the rapid intensification of tropical cyclones with intensities less than 33 m/s. For TCs with intensities higher than 33 m/s, the structure with a stable maximum wind speed radius may not persist for 24 hours during rapid intensification. Therefore, a continuous increase in the maximum sustained wind speed reaching 10 m/s within 12 hours is also defined as the rapid intensification. The present disclosure uses this criterion to define the rapid intensification during the research period.

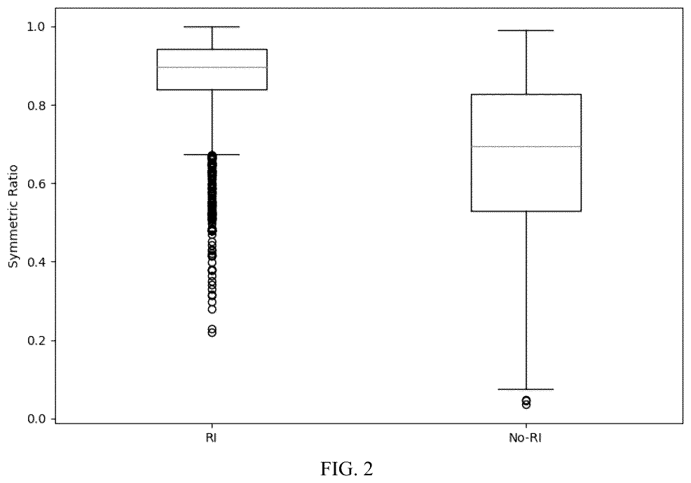

Specifically, FIG. 2 shows a statistical boxplot of convection symmetry indexes of tropical cyclones in the Northwestern Pacific Ocean during the rapid intensification (RI) phase and the non-rapid intensification (No-RI) phase from 2009 to 2021. As can be seen from FIG. 2, both the median and minimum values of the convection symmetry indexes during the rapid intensification stage are higher than those during the non-rapid intensification stage, indicating that the better the symmetry of a tropical cyclone, the more likely undergo rapid intensification.

2, performing comparative analysis on second characteristics of convection symmetry indexes during the rapid intensification phase of tropical cyclones with different grades, and constructing a second boxplot for analysis, wherein the grade of a tropical cyclone is determined based on the magnitude of the maximum wind speed near the TC center.

It should be noted that according to the PRC National Standard of Grades of Tropical Cyclones (GB/T 19201-2006), the intensity grades of tropical cyclones are classified as follows: tropical storm (TS) with a maximum wind speed near the center ranging from 17.2 to 24.4 m/s, severe tropical storm (STS) with a maximum wind speed near the center ranging from 24.5 to 32.6 m/s, typhoon (TY) with a maximum wind speed near the center ranging from 32.7 to 41.4 m/s, severe typhoon (STY) with a maximum wind speed near the center ranging from 41.5 to 50.9 m/s, and super typhoon (SuperTY) with a maximum wind speed near the center exceeding 51.0 m/s.

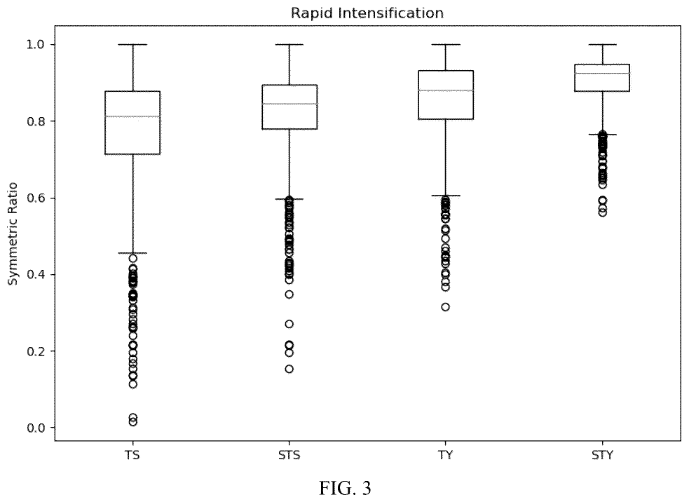

Specifically, FIG. 3 shows a statistical boxplot of convection symmetry indexes of TCs with different grades undergoing rapid intensification in the Northwestern Pacific Ocean from 2009 to 2021. According to the statistical results, the higher the grade of a tropical cyclone, the greater the median and minimum values of the convection symmetry index, indicating that the convection within the inner core of TC is more compact and symmetric.

3, performing comparative analysis on third characteristics of the convection symmetry indexes varying with time during the rapid intensification phase, and constructing a third boxplot for analysis.

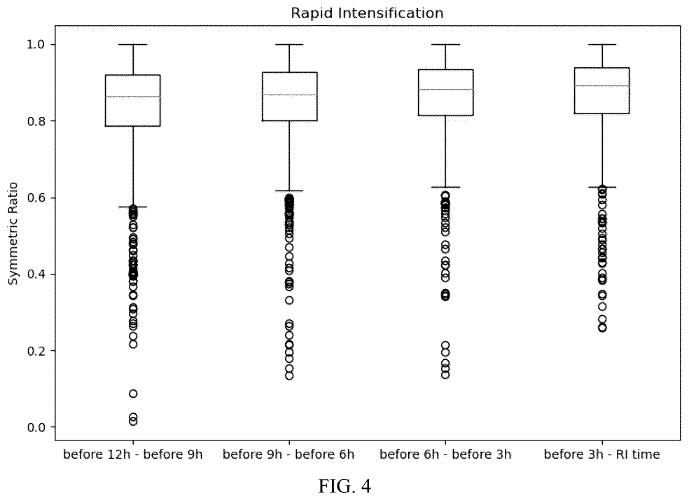

Specifically, to analyze the variation characteristics of convection symmetry indexes during the rapid intensification phase, the rapid intensification process is divided into four stages for statistical analysis. FIG. 4 shows a statistical boxplot of convection symmetry indexes varying with time during the rapid intensification phase. As can be seen from FIG. 4, during the rapid intensification phase, the median values of the convection symmetry indexes gradually increase over time, indicating that the convection within the inner cores of tropical cyclones tends to become more symmetric during the rapid intensification process.

Further, the convection symmetry index is added to TC intensity prediction models.

In this embodiment, the hourly center locations of TCs are obtained based on the best track datasets, corresponding polar coordinate systems are created with the center locations of TCs as the origins, the hourly infrared brightness temperature data are acquired from satellite data, and are interpolated into polar grid points based on the temporal correspondence to obtain infrared brightness temperature polar grid data, then the infrared brightness temperature polar grid data are used to define the convection symmetry indexes of the inner-core regions of TCs, and finally, the relationship between the convection symmetry indexes and the TC intensities is analyzed, and accurately reflects the variation characteristics of convection symmetry within the inner cores of the tropical cyclones during changes in tropical cyclone intensity, so that researchers can conveniently explore the application of the convection symmetry indexes in tropical cyclone intensity forecasting.

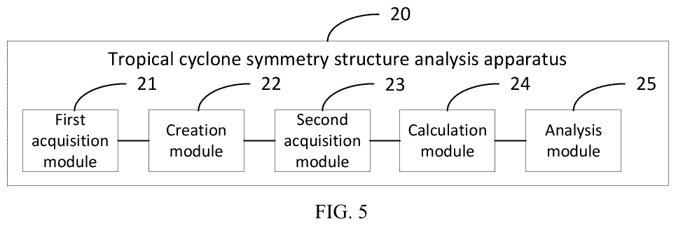

FIG. 5 is a schematic diagram of functional modules of a tropical cyclone symmetry structure analysis apparatus according to an embodiment of the present disclosure. As shown in FIG. 5, the tropical cyclone symmetry structure analysis apparatus 20 includes a first acquisition module 21, a creation module 22, a second acquisition module 23, a calculation module 24, and an analysis module 25.

The first acquisition module 21 is configured to acquire best track datasets in a preset time period, and use linear interpolation to acquire hourly TC locations and TC intensities;
the creation module 22 is configured to create corresponding polar coordinate systems with the center locations of TCs as the origins;
the second acquisition module 23 is configured to acquire hourly infrared brightness temperature data, and interpolate the infrared brightness temperature data into the corresponding polar grids based on a temporal correspondence to obtain infrared brightness temperature polar grid data;
the calculation module 24 is configured to calculate convection symmetry indexes of preset inner-core regions of TCs based on the infrared brightness temperature polar grid data;
the analysis module 25 is configured to analyze the relationship between the convection symmetry indexes and the TC intensities.

Optionally, the operation of calculating convection symmetry indexes of preset inner-core regions of the tropical cyclones based on the infrared brightness temperature polar grid data performed by the calculation module 24, specifically includes: calculating a 10% quantile and a 90% quantile of the infrared brightness temperature polar grid data of the preset inner-core regions of the tropical cyclones; and calculating convection symmetry indexes in combination with the difference of the 10% quantile and the 90% quantile.

Optionally, the calculation formula for the convection symmetry index is expressed as:

$$Symmetric Ratio = 1 - ( 90 \% TBB - 10 \% TBB ) / maximum ( 90 \% TBB - 10 \% TBB ) ;$$

where Symmetric Ratio represents the convection symmetry index, TBB represents the infrared brightness temperature polar grid data, and maximum (90% TBB−10% TBB) represents a preset climate value.

Optionally, the operation of interpolating the infrared brightness temperature data into polar grids of the corresponding polar coordinate systems based on a temporal correspondence to obtain infrared brightness temperature polar grid data performed by the second acquisition module 23, specifically includes: identifying target polar grid points with a spacing of 4 km in the direction of radius r and 5° in the direction of azimuthal angle θ of each polar coordinate system; and interpolating the infrared brightness temperature data into the target polar grid points of the corresponding polar coordinate systems based on the temporal correspondence to obtain the infrared brightness temperature polar grid data.

Optionally, the preset inner-core region of the tropical cyclone includes a circular ring region taking the TC center as a circle center and located between a first preset radius and a second preset radius, wherein the first preset radius is smaller than the second preset radius.

Optionally, the operation of analyzing the relationship between the convection symmetry indexes and the TC intensities performed by the analysis module 25, specifically includes: performing comparative analysis on first characteristics of convection symmetry indexes during the rapid intensification phase and the non-rapid intensification phase of the tropical cyclones, and constructing a first boxplot for analysis, wherein the rapid intensification phase and the non-rapid intensification phase are determined based on the magnitude of the continuously increasing maximum sustained wind speed within a preset time period; performing comparative analysis on second characteristics of convection symmetry indexes during the rapid intensification phase of tropical cyclones with different grades, and constructing a second boxplot for analysis, wherein the grade of a tropical cyclone is determined based on the magnitude of the maximum wind speed near the TC center; and performing comparative analysis on third characteristics of the convection symmetry indexes varying with time during the rapid intensification phase of the tropical cyclones, and constructing a third boxplot for analysis.

Optionally, the convection symmetry index is added as a potential factor to tropical cyclone intensity prediction models.

With respect to other details of the technical solution implemented by modules in the tropical cyclone symmetry structure analysis apparatus of the above embodiment, reference may be made to the description in the tropical cyclone symmetry structure analysis method of the above embodiment, which will not be repeated here.

It should be noted that all the embodiments in the description are described in a progressive way, and each embodiment focuses on the differences from other embodiments, so it is only necessary to refer to the same and similar parts of each embodiment. The apparatus embodiments are relatively simple to describe because they are substantially similar to the method embodiments, and reference is made to the partial description of the method embodiments, where relevant.

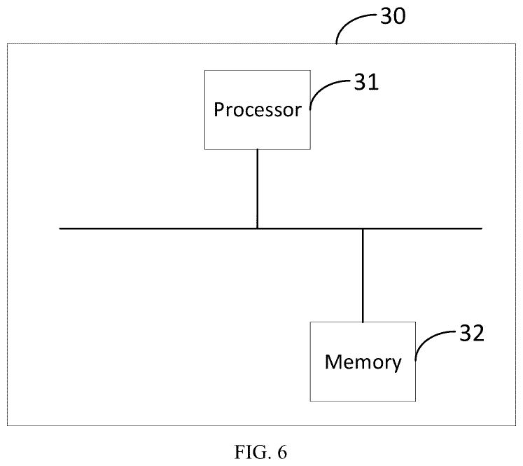

Referring to FIG. 6, which is a structural schematic diagram of a computer device according to an embodiment of the present disclosure. As shown in FIG. 6, the computer device 30 includes a processor 31 and a memory 32 coupled to the processor 31, wherein the memory 32 stores program instructions that, when executed by the processor 31, cause the processor 31 to perform the steps of the tropical cyclone symmetry structure analysis method of any of the above embodiments.

The processor 31 may also be referred to as a CPU (Central Processing Unit). The processor 31 may be an integrated circuit chip having signal processing capabilities. The processor 31 may also be a general-purpose processor, a digital signal processor (DSP), an application specific integrated circuit (ASIC), a field programmable gate array (FPGA) or other programmable logic device, discrete gate or transistor logic, discrete hardware components. The general-purpose processor may be a microprocessor or the processor may be any conventional processor or the like.

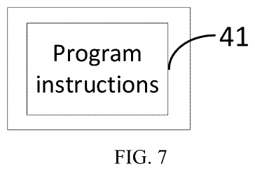

Referring to FIG. 7, which is a structural schematic diagram of a storage medium according to an embodiment of the present disclosure. The storage medium of the embodiment of the present disclosure stores program instructions 41 capable of implementing the above-mentioned tropical cyclone symmetry structure analysis method, wherein the program instructions 41 may be stored in the storage medium in the form of a software product and include several instructions for causing a computer device (which may be a personal computer, a server, a network device, or the like) or a processor to execute all or a part of the steps of the method according to the various embodiments of the present disclosure. The storage medium includes various media that can store program codes, such as a USB flash disk, a mobile hard disk, Read-Only Memory (ROM), Random Access Memory (RAM), a magnetic disk or an optical disk, or a computer device such as a computer, a server, a mobile phone, and a tablet.

In the several embodiments provided by the present disclosure, it should be understood that the disclosed computer device, apparatus and method may be implemented in other ways. For example, the apparatus embodiments described above are merely illustrative, e.g., the division of elements is only one logical function, and other divisions may be actually implemented, e.g., multiple elements or components may be combined or integrated into another system, or some features may be omitted or not performed. On the other hand, the mutual coupling or direct coupling or communication connection shown or discussed may be indirect coupling or communication connection through some interfaces, devices or units, which may be electrical, mechanical or other forms.

In addition, the functional units in each embodiment of the present disclosure may be integrated into one processing unit, or may be physically present individually, or two or more units may be integrated into one unit. The integrated unit may be implemented in the form of hardware or in the form of a software functional unit.

The above embodiments are merely exemplary embodiments of the present disclosure and are not intended to limit the scope of the present disclosure, and equivalent structures or equivalent process transformation made by using the contents of the description and drawings, or directly or indirectly applied to other related technical fields, are included in the scope of the present disclosure.

What is claimed is:

1. A tropical cyclone symmetry structure analysis method, comprising:
acquiring TC (Tropical Cyclone) best track datasets in a preset time period, and acquiring hourly TC center locations and TC intensities based on the TC best track datasets;
creating corresponding polar coordinate systems with the TC center locations as origins;
acquiring hourly infrared brightness temperature data, and interpolating the infrared brightness temperature data into polar grids of the corresponding polar coordinate systems based on a temporal correspondence to obtain infrared brightness temperature polar grid data;
calculating convection symmetry indexes of preset inner-core regions of TCs based on the infrared brightness temperature polar grid data; and
analyzing a relationship between the convection symmetry indexes and the TC intensities.

2. The tropical cyclone symmetry structure analysis method according to claim 1, wherein the calculating convection symmetry indexes of preset inner-core regions of TCs based on the infrared brightness temperature polar grid data comprises:
calculating a 10% quantile and a 90% quantile of the infrared brightness temperature polar grid data of the preset inner-core regions of TCs; and
calculating convection symmetry indexes of TCs in combination with a difference of the 10% quantile and the 90% quantile.

3. The tropical cyclone symmetry structure analysis method according to claim 2, wherein a calculation formula of the convection symmetry index is expressed as:
$$Symmetric Ratio = 1 - ( 90 \% TBB - 10 \% TBB ) / maximum ( 90 \% TBB - 10 \% TBB ) ;$$
where Symmetric Ratio represents the convection symmetry index, TBB represents the infrared brightness temperature polar grid data, and maximum (90% TBB−10% TBB) represents a preset climate value.

4. The tropical cyclone symmetry structure analysis method according to claim 3, wherein the interpolating the infrared brightness temperature data into polar grids of the corresponding polar coordinate systems based on a temporal correspondence to obtain infrared brightness temperature polar grid data comprises:
identifying target polar grid points with a spacing of 4 km in a direction of radius r and 5° in a direction of azimuthal angle θ of each polar coordinate system; and
interpolating the infrared brightness temperature data into the target polar grid points of the corresponding polar coordinate systems based on the temporal correspondence to obtain the infrared brightness temperature polar grid data.

5. The tropical cyclone symmetry structure analysis method according to claim 4, wherein the preset inner-core regions of TCs each comprise a circular ring region taking the TC center as a circle center and located between a first preset radius and a second preset radius, wherein the first preset radius is smaller than the second preset radius.

6. The tropical cyclone symmetry structure analysis method according to claim 5, wherein the analyzing a relationship between the convection symmetry indexes and the TC intensities comprises:
performing comparative analysis on first characteristics of the convection symmetry indexes during a rapid intensification phase and a non-rapid intensification phase of the tropical cyclones, and constructing a first boxplot for analysis, wherein the rapid intensification phase and the non-rapid intensification phase are determined based on a magnitude of a continuously increasing maximum sustained wind speed within a preset time period;
performing comparative analysis on second characteristics of the convection symmetry indexes during a rapid intensification phase of tropical cyclones with different grades, and constructing a second boxplot for analysis, wherein the grade of a tropical cyclone is determined based on a magnitude of the maximum wind speed near the TC center; and
performing comparative analysis on third characteristics of the convection symmetry indexes varying with time during the rapid intensification phase of the tropical cyclones, and constructing a third boxplot for analysis.

7. The tropical cyclone symmetry structure analysis method according to claim 6, wherein the convection symmetry index is added as a potential factor to TC intensity prediction models.

8. A tropical cyclone symmetry structure analysis apparatus, comprising:
a first acquisition module, configured to acquire TC best track datasets in a preset time period, and acquire hourly TC locations and TC intensities based on the TC best track datasets;
a creation module, configured to create corresponding polar coordinate systems with TC center locations as origins;
a second acquisition module, configured to acquire hourly infrared brightness temperature data, and interpolate the infrared brightness temperature data into polar grids of the corresponding polar coordinate systems of TCs based on a temporal correspondence to obtain infrared brightness temperature polar grid data;
a calculation module, configured to calculate convection symmetry indexes of preset inner-core regions of TCs based on the infrared brightness temperature polar grid data; and
an analysis module, configured to analyze a relationship between the convection symmetry indexes and the TC intensities.

9. A computer device, comprising a processor and a memory coupled to the processor, wherein the memory stores program instructions, and the program instructions, when executed by the processor, cause the processor to execute the steps of the tropical cyclone symmetry structure analysis method according to claim 1.

10. A storage medium, storing program instructions capable of implementing the tropical cyclone symmetry structure analysis method according to claim 1.
